(19) United States
(12) Patent Application Publication
(10) Pub. No.: US 2012/0288603 A1
(43) Pub. Date: Nov. 15, 2012

(54) Device and Method for the Treatment of a Liquid Foodstuff Product

(75) Inventors: Matthias Weinzierl, Eching (DE); Stefan Höller, Regensburg (DE); Werner Glasser, Wolfersdorf (DE)

(73) Assignee: KRONES AG, Neutraubling (DE)

(21) Appl. No.: 13/449,495

(22) Filed: Apr. 18, 2012

(30) Foreign Application Priority Data
Apr. 20, 2011 (DE) 102011007787.1

(51) Int. Cl. A23L 2/46; A23C 9/00; A23L 2/02

(52) U.S. Cl. 426/521; 99/275; 99/453

(57) ABSTRACT

In a device for treating a liquid foodstuff product containing a solid with a heat exchanger charged with the foodstuff product under pressure and/or a degasser, which is charged with a reduced pressure, followed or preceded by a pressure reduction device, the pressure reduction device has at least one brake pump through which the foodstuff product flows. In a method the pressure with which the foodstuff product is conveyed through the brake pump is reduced by a rotary movement of the brake pump.

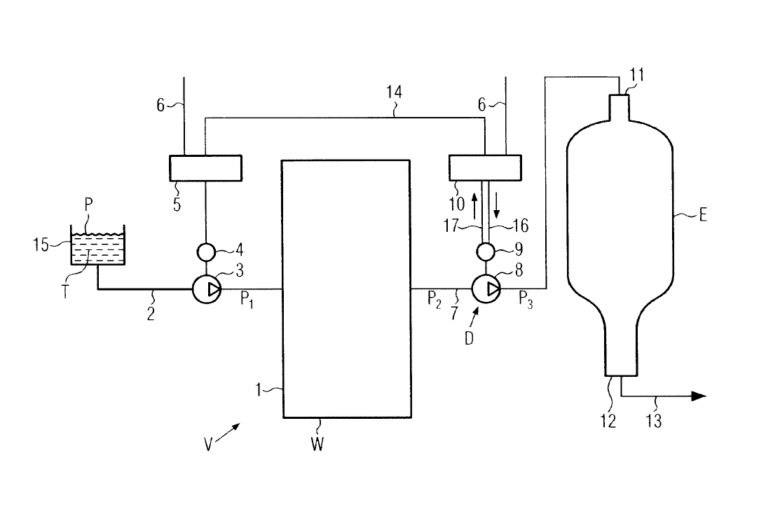

### CROSS-REFERENCE TO RELATED APPLICATION

The present application claims the benefit of priority of German Application No. 102011007787.1, filed Apr. 20, 2012. The entire text of the priority application is incorporated herein by reference in its entirety.

### FIELD OF THE DISCLOSURE

The disclosure relates to a pressure reduction device and a method for reducing pressure in a liquid foodstuff product, during a portion of the foodstuff treating and filling operations.

### BACKGROUND

In the filling technology of liquid foodstuff products, such as fruit juices, milk products or similar items, devices, for example, for pasteurizing and/or degassing are used, in which the foodstuff product is conveyed under pressure through a heat exchanger and is then optionally supplied to a degasser (e.g. vacuum container). With regard to the high throughput and efficient heat exchange as well as an exactly controllable product flow, the foodstuff product is conveyed with relatively high pressure through the heat exchanger. This high pressure must be reduced in the further processing sequence downstream from the heat exchanger or at least significantly reduced, in particular when the foodstuff product is then supplied to a degasser in which the degassing effect only takes place with relatively little pressure or negative pressure. In addition, relatively much energy is dissipated unused with this method.

In devices of this nature it is therefore known that a pressure reduction device, in which the required pressure reduction runs under control, can be provided at the output of the heat exchanger and/or upstream from the degasser. The known pressure reduction devices comprise at least one control valve which produces the required drop in pressure by means of at least one fixed or variable throttle point. Flowing through the throttle point represents a relatively high mechanical stress on the foodstuff product, because here the pressure reduction occurs almost instantaneously. With relatively high homogeneous and/or sometimes also highly viscous liquid foodstuff products, this mechanical stress is accepted optionally without subsequent impairment on the quality. With liquid foodstuff products containing solids and optionally of low viscosity, such as fruit juices with fibers, pulps, pieces of fruit, sacks or similar or milk products with additives, the mechanical stress can cause damage to the more solid constituents in the relatively narrow gap of the throttle point (damage rate) and therefore sustainably impair the quality of the treated foodstuff product. A further disadvantage is that solids are deposited in a narrow throttle gap and can reinforce the predetermined throttle effect at times so that the predetermined pressure difference during pressure reduction cannot be kept adequately uniform. The pressure reduction through only at least one throttle gap can also lead to undesired heating or cavitation, which is unfavorable both for the foodstuff product and for the control valve. Finally, pressure reduction over at least one throttle gap signifies energy dissipation, because the pressure or kinetic energy contained in the foodstuff product due to friction and shear forces is converted into unusable heat energy or is dissipated.

### SUMMARY OF THE DISCLOSURE

One aspect of the disclosure is to provide a device and method of the type mentioned in the introduction with which a pressure reduction, particularly in a liquid foodstuff product containing a solid, can be carried out more gently for the product and with more conservation of the pressure reduction device than before. Part of the object is also not to dissipate unused energy extracted from the foodstuff product during pressure reduction, but rather to recover it or recycle it to a useful extent.

The brake pump in the device operates like a hydraulic motor which is driven by the pressurized foodstuff product and reduces the pressure without a narrow throttle gap principally by means of an expansion in conjunction with a rotary movement. The brake pump acts as a hydraulic motor, which takes up the foodstuff product with the increased conveying pressure, is driven by it, and delivers it unpressurized or with significantly reduced pressure or largely relieved. Here, the foodstuff product does not need to pass through any narrow gaps, but rather it can gently relax in the brake pump, so that the solids are not damaged and also the brake pump itself is not subjected to any significant mechanical stress. The pressure reduction also occurs distributed over the drive power taken up by the brake pump during the flow through of the foodstuff product. During the treatment of the foodstuff product, the more solid constituent parts sustain no damage due to the pressure build-up, so that the foodstuff product has a uniform high quality.

According to the method the pressure reduction is carried out downstream of the heat exchanger and/or upstream of the degasser without significant damage of the solids and thus favorable for the quality of the foodstuff product during the flow through and the driving of the brake pump, which gradually relieves the pressurized, conveyed foodstuff product over a relatively long through-flow distance, thereby absorbing drive energy. The brake pump can only be driven by the foodstuff product or driven or also braked at a controlled speed by an auxiliary drive. The brake pump delivers a largely constant product flow and, with appropriate design, can process relatively high flow rates and reduce a relatively large pressure difference.

With an expedient embodiment of the device the brake pump is a positive displacement pump, such as a rotary vane feeder, gear pump or a diaphragm pump, at least partly driven by the foodstuff product. The power taken up during the pressure reduction is converted into a rotary movement. The pressure reduction can be finely controlled by this rotary movement. A rotary vane feeder or diaphragm pump offers the additional advantage that the foodstuff product has no or no significant contact with, for example, lubricated components of the brake pump. A rotary vane feeder, gear pump or diaphragm pump also offers the advantage of distributing the pressure reduction over a relatively wide speed range or relatively large flow length without using narrow throttle gaps which is an advantage for the quality of the treated foodstuff product.

In an expedient embodiment of the device a feed pump driven with electrical primary energy is provided upstream of the heat exchanger, which can represent, for example, a preheating section of the device with said feed pump producing in the foodstuff product the feed pressure and volume flow which is needed for the flow through the heat exchanger and which is needed for an efficient and predetermined heat exchange effect and a high throughput rate. Expediently, the feed pump is a screw pump or a diaphragm pump, which can easily handle the consistency of the foodstuff product containing the more solid constituent parts, although also other types of pump can be used.

In an expedient embodiment of the device the degasser is arranged after the heat exchanger and the at least one brake pump is located in a feed section from the heat exchanger to the degasser. This concept is not just expedient with regard to perfect cleaning, but rather it also ensures that the pressure reduction affects neither the uniform outflow from the heat exchanger nor the uniform inflow into the degasser.

In order to precisely set the pressure reduction in the brake pump, in a further embodiment the brake pump can be electrically driven or electrically or mechanically braked. The electrical drive principle can be used for example in a start-up phase until a uniform product flow or mass flow has become established, for example also to overcome the start-up resistance of the brake pump. In contrast, with a continuously running process a permanent braking with fixed or controllable intensity may be expedient in order to reduce a predetermined pressure difference which has remained the same.

In order not to leave the energy removed from the foodstuff product by the brake pump during pressure reduction unused, in a particularly expedient embodiment the brake pump is coupled to an electric generator (electric brake) or is formed as such in order for the generator to produce electrical energy which can be used in or outside of the device for other purposes. Expediently, the generator is an electric motor which can be optionally operated with a drive function or a generator function.

Since for a high throughput rate and due to the consistency of the foodstuff product the feed pump needs a relatively great deal of electrical primary energy, the electrical energy, produced by the generator of the brake pump during pressure reduction, for driving the feed pump or its drive assistance, is applied such that at least a part of the primary energy needed by the feed pump for the supply can be saved. Alternatively, other, electrically dependent components of the device or also other components outside of the device can use the electrical energy produced from the pressure reduction, or this energy could be saved in a store for further use.

In an expedient embodiment the generator of the brake pump, as also an electric motor of the feed pump, are each assigned a frequency converter in order to be able to exactly control the torque or the speed of the relevant pump, and via a connection between the frequency converters the electrical energy recovered during pressure reduction is used via the frequency converter of the feed pump for the drive of the feed pump or for drive assistance. During power generation an electrical braking effect can also be finely controlled via the frequency converter of the brake pump.

In an expedient embodiment at least the brake pump is formed either with constant displacement or with variable displacement, for example as a variable displacement pump. A variable displacement offers the advantage of an additional operating parameter for the fine control of the pressure reduction.

Finally, according to the method it is expedient that the energy released by the foodstuff product during pressure reduction in the brake pump is converted into electrical energy and generally used for making savings of electrical primary energy. In this way the energy balance of the method can be significantly improved.

### BRIEF DESCRIPTION OF THE DRAWINGS

An embodiment of the disclosure is explained based on the drawing.

The figure shows a schematic illustration in a type of block diagram of a device V for the treatment of liquid foodstuff products P.

### DETAILED DESCRIPTION OF THE PREFERRED EMBODIMENT

The device V is, for example, used in filling technology for fruit juices or milk products or similar items. The device V is particularly suitable for liquid foodstuff products containing solids such as fibers, pulps, fruit pieces, sacks and similar items, but could also be used for manufacturing beer, for example, for the mash or during the filling of yoghurt containing additives.

The device V has a heat exchanger W, which for example defines a preheating section 1, and through which a liquid foodstuff product P containing a solid T is conveyed for example by an electrically driven feed pump 3 with predefined feed pressure P1 in a predefined product flow via a feed section 2 from a reservoir 15 and is heat treated, e.g. pasteurized. The feed pump 3 is connected to an electrical drive motor 4. The electric motor 4 could be included in the feed pump 3 and in the embodiment is connected to a frequency converter 5, which for example receives electrical primary energy over a line 6. Downstream of the heat exchanger W a further feed section 7 extends, in which a pressure reduction device D is provided to reduce the pressure of the foodstuff product P from a heat exchanger output pressure P2 to a lower pressure P3 or to remove it completely. On the output of the pressure reduction device D the foodstuff product P is present unpressurized or largely unpressurized.

The pressure reduction device D comprises at least one brake pump 8, which expediently is a positive displacement pump. A brake pump 8 in the form of a rotary vane feeder, a diaphragm pump or a gear pump, i.e. a pump with a rotating pump element, is particularly suitable. In the illustrated embodiment the brake pump 8 has an assigned electrical generator 9 which can be included in the brake pump 8 and is connected through lines 17, 16 to a frequency converter 10. The frequency converter 10 can obtain electrical primary energy through a line 6, for example, in order to drive the brake pump 8 via the generator 9 with a selectable speed or to brake the brake pump 8 driven by the flowing foodstuff product P to a selectable extent, for example, electrically. The generator 9 can alternatively be operated as a drive motor or electrical generator. As a drive motor it is, for example, controlled via the line 16. As the generator 9 driven from the brake pump 8 it produces electrical energy, which for example is brought to the frequency converter 10 via the line 17. Both frequency converters 5, 10 are connected to one another, for example via a line 14, or are constructively combined such that the recovered electrical energy for driving the feed pump 3 can be used, so that electrical primary energy for the feed pump 3 can be saved.

Alternatively the brake pump 8 can be braked mechanically and controllably.

The task of the brake pump 8 is primarily to implement the pressure reduction in the conveyed foodstuff product P from pressure P2 to pressure P3 without a narrow throttle gap using the displacement effect and relaxation in order not to damage the solids T in the foodstuff product P. The secondary task of the brake pump 8 is to recover electrical energy from the power taken up during pressure reduction from the mass flow of the foodstuff product P.

In the illustrated embodiment the heat exchanger W is optionally followed by a degasser E (e.g. vacuum container), the inlet 11 of which is connected to the feed section 7 downstream from the brake pump 8 and is used to degas the foodstuff product P before a feed section 13 at the output 12 of the degasser E. The feed section 7 leading to the inlet 11 of the degasser E contains the brake pump 8 for the pressure reduction from pressure P2 to the pressure P3.

The feed section 13 leads for example to further heat exchanger sections, required product treatment components elsewhere, or directly to a filler.

The feed pump 3 is expediently an electrically driven screw pump, a gear pump, a rotary vane feeder or a diaphragm pump.

An electronic control device, not illustrated, for the device V regulates the energy flows and the speeds or powers of the feed pump 3 and the brake pump 8.

The pressure reduction device D could optionally comprise a plurality of brake pumps 8 connected in series from which optionally electrical energy could be recovered from at least one or all of them and the pressure reduction implemented more gently over several stages for the foodstuff product.

The device V could be formed without the heat exchanger W and with at least one treatment station, which requires a pressure reduction of a conveyed, pressurized foodstuff product. Also in this case the brake pump 8 could be placed upstream, with or without energy recovery.

Instead of the heat exchanger W at least one other treatment station could be provided in the device, which renders conveyance of the foodstuff product under high pressure necessary, the pressure again being reduced completely or to a certain extent with the brake pump 8.

1. A device for treating a liquid foodstuff product containing a solid, comprising one of a heat exchanger charged with the foodstuff product, a degasser, and a combination thereof which is preceded or followed by a pressure reduction device, the pressure reduction device having at least one brake pump (8) through which the foodstuff product flows under feed pressure.

2. The device according to claim 1, wherein the brake pump is a positive displacement pump at least partly rotationally driven by the foodstuff product.

3. The device according to claim 1, and wherein upstream from the heat exchanger, a feed pump operated with electrical primary energy is provided.

4. The device according to claim 1, wherein the degasser is located after the heat exchanger and that the brake pump is arranged in a feed section from the heat exchanger to the degasser.

5. The device according to claim 1, wherein the brake pump can be driven or braked electrically.

6. The device according to claim 1, and wherein the brake pump is coupled to an electrical generator, and electrical energy can be produced by the brake pump via the generator from energy taken into the brake pump from the conveyed foodstuff product.

7. The device according to claim 6, wherein electrical energy produced by the generator via the brake pump can be used at least partially to supply another component of the device.

8. The device according to claim 3, and wherein a frequency converter is connected to another frequency converter in the device which is assigned to the generator of the brake pump.

9. The device according to claim 1, wherein the brake pump is formed with constant displacement or variable displacement.

10. A method for the treatment of a liquid, conveyed foodstuff product, containing a solid, in a device having one of at least one heat exchanger, degasser, and a combination thereof, comprising conveying the foodstuff product through at least one brake pump with a pressure and wherein the pressure is completely reduced or reduced to a lower pressure downstream of the heat exchanger to upstream of the degasser by a drive movement of the brake pump.

11. The method according to claim 10, and converting into electrical energy the energy dissipated into the brake pump by the foodstuff product from the pressure difference during pressure reduction in the brake pump by a generator driven by the brake pump, and using the converted electrical energy for saving primary energy.

12. The device according to claim 2, wherein the positive displacement pump is one of a rotary vane feeder pump, a gear pump, and a diaphragm pump.

13. The device according to claim 3, wherein the heat exchanger is a heat exchanger of a preheating section.

14. The device according to claim 3, wherein the feed pump is a screw pump or a diaphragm pump with an electric drive motor.

15. The device according to claim 6, wherein the electrical generator can be operated alternatively as an electric motor or as a generator.

16. The device according to claim 7, wherein the another component of the device comprises a feed pump arranged upstream of the heat exchanger.

17. The device according to claim 8, wherein the another frequency convertor in the device is that of the feed pump.

18. The device according to claim 11, and wherein the converted electrical energy is used for saving primary energy in the device for one of driving and assisting in the driving of a feed pump.
